(19) United States
(12) Patent Application Publication
(10) Pub. No.: US 2026/0261070 A1
(43) Pub. Date: Sep. 3, 2026

(54) FIRST CONNECTOR, SECOND CONNECTOR, AND CONNECTOR ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroya TANAKA, Mie (JP); Yuta KANEMATSU, Mie (JP); Jaeyeon KIM, Mie (JP); Sunghyun BYUN, Mie (JP)

(21) Appl. No.: 18/878,656

(22) PCT Filed: Jun. 14, 2023
(86) PCT No.: PCT/JP2023/022005

§ 371 Date: Dec. 24, 2024

(30) Foreign Application Priority Data
Jun. 28, 2022 (JP) 2022-103641

(51) Int. Cl. H01R 13/453

(52) U.S. Cl. CPC H01R 13/4538

(57) ABSTRACT

A first connector includes a first terminal member, a first connector housing and a slide member. The slide member is slidable between a closing position and an opening position with respect to the first connector housing. The slide member includes a lateral protection wall portion projecting further than the first terminal member while being separated from the first terminal member and covering the first terminal member at the closed position, a front protection wall portion for covering a tip opening of the lateral protection wall portion and a terminal insertion hole provided through the front protection wall portion to allow insertion of the first terminal member. The first terminal member is inserted through the terminal insertion hole of the slide member and projects from the front protection wall portion with the slide member moved to the opening position.

### TECHNICAL FIELD

The present disclosure relates to a first connector, a second connector and a connector assembly.

### BACKGROUND

Conventionally, a connector assembly assembled by connecting a first connector and a second connector to each other is used in power transmission between in-vehicle components such as a high voltage battery and an inverter. In such a connector assembly, a structure for preventing an electric shock due to the contact of worker's fingers with terminals of the respective connectors needs to be provided. For example, to surround a terminal on three sides by a protective collar having a U-shaped cross-section and route a terminal of a mating connector to be connected to the terminal in an orthogonal direction, a structure in which the protective collar is open laterally and forward and surfaces of the terminal exposed on the lateral and front sides of the protective collar are covered by a protecting member made of resin and assembled with the terminal is proposed in a connector described in Patent Document 1.

### PRIOR ART DOCUMENT

### Patent Document

Patent Document 1: JP 2016-522550 A

### SUMMARY OF THE INVENTION

### Problems to be Solved

However, since the surfaces of the terminal exposed from the protective collar need to be covered by assembling the protecting member made of resin with the terminal in the structure of Patent Document 1, the structure of the terminal is complicated. Further, since the lateral and front openings of the protective collar are not covered, a finger may unexpectedly touch the terminal.

Accordingly, a first connector, a second connector and a connector assembly are disclosed which can simplify the structure of a terminal and improve an electric shock preventing effect by reducing a possibility of finger touch with the terminal.

### Means to Solve the Problem

A first connector assembly of the present disclosure is to be detachably assembled with a second connector and provided with a first terminal member having a tip side extending in a first direction, a first connector housing for holding the first terminal member and a slide member held in the first connector housing, the slide member being slidable with respect to the first connector housing between a closing position located on an end part in the first direction and an opening position located on an end part in a first opposite direction opposite to the first direction, the slide member including a lateral protection wall portion projecting further in the first direction than the first terminal member while being separated from the first terminal member and covering the first terminal member in a direction orthogonal to the first direction in the first terminal member at the closing position, a front protection wall portion for covering a tip opening of the lateral protection wall portion and a terminal insertion hole provided through the front protection wall portion to allow insertion of the first terminal member, and the first terminal member being inserted through the terminal insertion hole of the slide member and projecting in the first direction from the front protection wall portion with the slide member moved to the opening position.

A second connector of the present disclosure is to be detachably assembled with the first connector of the present disclosure and provided with a second terminal member to be connected to the first terminal member of the first connector, a second connector housing for holding the second terminal member, a pressing portion for sliding the slide member to the opening position by pressing a pressed portion provided in the slide member when the second connector is attached to the first connector, and an engaging portion for sliding the slide member to the closing position by being engaged with an engaged portion provided in the slide member and pulling the engaged portion in a separation direction from the first connector when the second connector is detached from the first connector.

A connector assembly of the present disclosure is provided with a first connector and a second connector to be detachably assembled with each other, the first connector of the present disclosure being used as the first connector, and the second connector of the present disclosure being used as the second connector.

### Effect of the Invention

According to the first connector, the second connector and the connector assembly of the present disclosure, it is possible to simplify the structure of a terminal and improve an electric shock preventing effect by reducing a possibility of finger touch with the terminal.

### BRIEF DESCRIPTION OF THE DRAWINGS

FIG. 1 is an exploded perspective view of a connector assembly in one embodiment.

FIG. 2 is a perspective view of the connector assembly shown in FIG. 1.

FIG. 3 is a front view of the connector assembly shown in FIG. 1.

FIG. 4 is a perspective view of a first connector in the embodiment in which a slide member is at a closing position.

FIG. 5 is a longitudinal section along V-V in FIG. 6 of the first connector shown in FIG. 4.

FIG. 6 is a section along VI-VI in FIG. 5.

FIG. 7 is a perspective view of the first connector in the embodiment in which the slide member is at an opening position.

FIG. 8 is a front view showing a state where the slide member is removed from the first connector shown in FIG. 7.

FIG. 9 is a perspective view of the slide member used in the first connector in the embodiment when viewed from an upper surface side.

FIG. 10 is a perspective view of the slide member used in the first connector in the embodiment when viewed from a lower surface side.

FIG. 11 is a perspective view of a second connector in the embodiment.

FIG. 12 is a section along XII-XII in FIG. 3 including an enlarged essential part.

FIG. 13 is an enlarged section along XIII-XIII in FIG. 3 of an essential part.

### DETAILED DESCRIPTION TO EXECUTE THE INVENTION

### Description of Embodiments of Present Disclosure

First, embodiments of the present disclosure are listed and described.
(1) The first connector of the present disclosure is to be detachably assembled with a second connector and provided with a first terminal member having a tip side extending in a first direction, a first connector housing for holding the first terminal member and a slide member held in the first connector housing, the slide member being slidable with respect to the first connector housing between a closing position located on an end part in the first direction and an opening position located on an end part in a first opposite direction opposite to the first direction, the slide member including a lateral protection wall portion projecting further in the first direction than the first terminal member while being separated from the first terminal member and covering the first terminal member in a direction orthogonal to the first direction in the first terminal member at the closing position, a front protection wall portion for covering a tip opening of the lateral protection wall portion and a terminal insertion hole provided through the front protection wall portion to allow insertion of the first terminal member, and the first terminal member being inserted through the terminal insertion hole of the slide member and projecting in the first direction from the front protection wall portion with the slide member moved to the opening position.

According to the first connector of the present disclosure, the slide member provided in the first connector includes the lateral protection wall portion for covering the first terminal member and the front protection wall portion for covering the tip opening of the lateral protection wall portion. At the closing position of the slide member, the lateral protection wall portion covers the first terminal member and the front protection wall portion covering the tip opening of the lateral protection wall portion covers the front surface of the first terminal member. Thus, a protecting member made of resin needs not be provided on the terminal unlike a conventional structure, and the structure of the terminal can be simplified. Further, since the periphery and front surface of the first terminal member are covered by the slide member, a possibility of finger touch with the terminal can be reduced and an electric shock preventing effect can be improved. Note that, if the first connector is provided with a plurality of the first terminal members, a slide member may be provided for each first terminal member or the plurality of first terminal members may be collectively surrounded by a single slide member. Further, an arbitrary shape such as a circular tube shape or a rectangular tube shape can be adopted as the shape of the lateral protection wall portion as long as the first terminal member can be surrounded.
(2) Preferably, a plurality of the first terminal members are provided and covered by the lateral protection wall portion and the front protection wall portion of the single slide member arranged at the closing position.

If the first connector is provided with the plurality of first terminal members, the plurality of first terminal members can be covered by the single slide member and a reduction in the number of components and miniaturization of the first connector can be achieved.
(3) Preferably, the first connector housing includes a terminal holding portion for holding a held portion located between the tip side and the base end side of the first terminal member and a slide rail insertion portion penetrating through an outer peripheral edge part of the terminal holding portion in the first direction, the slide member includes a slide rail extending in the first opposite direction from the front protection wall portion of the slide member and the slide rail is inserted into the slide rail insertion portion movably in the first direction and the first opposite direction, and a displacement of the slide member in a direction orthogonal to the first direction is restricted by contact of the slide rail with the slide rail insertion portion.

By inserting the slide rail provided in the slide member into the slide rail insertion portion provided in the connector housing, the slide member can be slidably held in the connector housing. Moreover, since a displacement of the slide member in the direction orthogonal to the first direction is restricted by the contact of the slide rail with the slide rail insertion portion, a risk of inclining the slide member during a sliding movement and causing the breakage of the slide member and the like associated with that can be reduced.
(4) Preferably, the lateral protection wall portion of the slide member includes a plurality of divided wall portions divided in a circumferential direction via a plurality of slits, and the slide rail includes the divided wall portion.

Since the slide rail is configured to include the divided wall portion constituting the lateral protection wall portion, the lateral protection wall portion can also function as the slide rail and the slide member can be reduced in size.
(5) Preferably, the slide rail includes an extending wall portion extending in the first opposite direction from the divided wall portion and the extending wall portion of the slide rail is inserted and arranged in the slide rail insertion portion of the first connector housing at the closing position.

Since the extending wall portion extending in the first opposite direction from the divided wall portion constituting the slide rail is inserted and arranged in the slide rail insertion portion at the closing position of the slide member, the slide rail can be reliably inserted and arranged in the slide rail insertion portion while the lateral protection wall portion is moving from the closing position for covering the first terminal member to the opening position. In this way, a sliding direction of the slide member can be reliably guided, and the inclination of the slide member during a movement and the breakage and the like associated with that can be more advantageously reduced.
(6) Preferably, a pair of the slide rail and the slide rail insertion portion are arranged to face each other on both sides across the first terminal member in two directions orthogonal to the first direction in the first terminal member.

Since the pair of the slide rail and the slide rail insertion portion are arranged to face each other on the both sides across the first terminal member in the two directions orthogonal to the first direction in the first terminal member, the slide rail can be inserted and arranged in the slide rail insertion portion on both sides in a vertical direction and both sides in a lateral direction across the first terminal member. In this way, the sliding direction can be more reliably guided while the rigidity and durability of the slide member are ensured.
(7) Preferably, the slide member includes a slide-side suppressing portion, and the first connector housing includes a connector-side suppressing portion for suppressing a movement of the slide member in the first opposite direction by being engaged with the slide-side suppressing portion with the slide member located at the closing position.

Since the first connector housing includes the connector-side suppressing portion for suppressing a movement of the slide member at the closing position in the first opposite direction, it is, for example, suppressed that the slide member easily slides to the opening position due to vibration or the like. In this way, the electric shock preventing effect for the first terminal member can be satisfactorily maintained.
(8) Preferably, the slide member includes a slide-side restricting portion, and the first connector housing includes a connector-side restricting portion for restricting a movement of the slide member in the first direction by being engaged with the slide-side restricting portion with the slide member located at the closing position.

Since the first connector housing includes the connector-side restricting portion for suppressing a movement of the slide member at the closing position in the first direction, the slide member is restricted from being detached from the first connector housing. In this way, the electric shock preventing effect for the first terminal member can be satisfactorily maintained.
(9) Preferably, the slide member includes a pressed portion to be pressed by a pressing portion provided in the second connector when the second connector is attached to the first connector, the pressed portion is provided in the front protection wall portion, and the slide member slides to the opening position by the pressed portion being pressed by the pressing portion.

Since the pressed portion is pressed by the pressing portion of the second connector to slide the slide member to the opening position when the second connector is attached to the first connector, the slide member needs not be slid to the opening position, for example, by a jig or the like. Thus, a worker can slide the slide member to the opening position without requiring a separate step only by attaching the second connector to the first connector. In addition, since the front protection wall portion of the slide member is provided with the pressed portion, the pressing portion of the second connector can stably slide the slide member in the first opposite direction by pressing the front protection wall portion provided on the tip of the slide member and planarly extending.
(10) Preferably, the slide member includes an engaged portion to be engaged with an engaging portion provided in the second connector and pulled in a separation direction of the second connector when the second connector is separated from the first connector, and the slide member slides to the closing position by the engaged portion being pulled by the engaging portion.

When the second connector is separated from the first connector, the engaging portion of the second connector can be engaged with the engaged portion of the slide member and can be pulled in the separation direction of the second connector. In this way, the slide member can be pulled in the separation direction, i.e. in the first direction, together with the second connector, and the slide member can be slid to the closing position. Therefore, the slide member needs not be slid to the closing position by a jig or the like, and the worker can slide the slide member to the closing position without requiring a separate step only by detaching the second connector from the first connector.
(11) Preferably, the slide member includes a contacted portion to be brought into contact with a contact portion provided in the second connector from a direction opposite to a projecting direction from the engaging portion to the engaged portion, and the contacted portion hinders a displacement of the engaging portion in the direction opposite to the projecting direction by being contacted by the contact portion.

A displacement of the engaging portion in the direction opposite to the projecting direction is hindered by the contact of the contacted portion provided in the slide member with the contact portion provided in the second connector, and an engaged state of the engaging portion with the engaged portion can be advantageously held. In this way, the occurrence of a trouble that the engaging portion is disengaged from the engaged portion and the slide member cannot be pulled to the closing position can be prevented or suppressed when the second connector is separated from the first connector.
(12) A second connector to be detachably assembled with the first connector of any one of (1) to (11) described above is provided with a second terminal member to be connected to the first terminal member of the first connector, a second connector housing for holding the second terminal member, a pressing portion for sliding the slide member to the opening position by pressing a pressed portion provided in the slide member when the second connector is attached to the first connector, and an engaging portion for sliding the slide member to the closing position by being engaged with an engaged portion provided in the slide member and pulling the engaged portion in a separation direction from the first connector when the second connector is detached from the first connector.

According to the second connector of the present disclosure, the slide member can be slid to the opening position by the pressing portion pressing the pressed portion provided in the slide member when the second connector is attached to the first connector. In this way, the worker can slide the slide member to the opening position without requiring a separate step only by attaching the second connector to the first connector. Since the first terminal member projects in the first direction from the front protection wall portion through the terminal insertion hole of the slide member when the slide member is moved to the opening position, the second terminal member can be connected to the first terminal member. Further, when the second connector is separated from the first connector, the engaging portion can be engaged with the engaged portion provided in the slide member and pull the engaged portion in the separation direction from the first connector, whereby the slide member can be slid to the closing position. The worker can slide the slide member to the closing position without requiring a separate step only by detaching the second connector from the first connector. Since the slide member can be moved to the closing position and surround the first terminal member by the second connector, the structure of the terminal can be simplified and the electric shock preventing effect can be improved by reducing a possibility of finger touch with the terminal.
(13) Preferably, in the second connector of (12) described above, the second connector housing includes an opening window for exposing the second terminal member to outside, the second connector further includes an insulating lid member for covering the opening window, a first terminal accommodation hole is provided through a central planar portion of the lid member and the pressing portion is constituted by a part of the central planar portion except the first terminal accommodation hole.

The second connector includes the insulating lid member for covering the opening window of the second connector housing, and the central planar portion of the lid member is provided with the first terminal insertion hole, through which the first terminal member is inserted to be connected to the second terminal member. Since the pressing portion is constituted by a planar region of the central planar portion except the first terminal insertion hole, a peripheral region of the front protection wall portion provided with the terminal insertion hole, through which the first terminal member is inserted, can be pressed over a wide contact area. In this way, the slide member of the first connector can be stably pressed when the second connector is attached to the first connector, and the occurrence of an inclined sliding movement of the slide member can be suppressed or prevented.
(14) Preferably, in the second connector of (12) or (13) described above, the second connector housing includes the engaging portion and a contact portion to be brought into contact with a contacted portion provided in the slide member in a direction opposite to a projecting direction of the engaging portion to the engaged portion, and the contacted portion hinders a displacement of the engaging portion in the direction opposite to the projecting direction by being contacted by the contact portion.

A displacement of the engaging portion in the direction opposite to the projecting direction is hindered by the contact of the contact portion provided in the second connector with the contacted portion provided in the slide member, and an engaged state of the engaging portion with the engaged portion can be advantageously held. In this way, the occurrence of a trouble that the engaging portion is disengaged from the engaged portion and the slide member cannot be pulled to the closing position can be prevented or suppressed when the second connector is separated from the first connector.
(15) A connector assembly is provided with a first connector and a second connector to be detachably assembled with each other, the first connector of any one of (1) to (11) described above being used as the first connector, and the second connector of any one of (12) to (14) described above being used as the second connector.

According to the connector assembly of the present disclosure, since the first connector of the present disclosure is used as the first connector and the second connector of the present disclosure is used as the second connector, the aforementioned functions and effects enjoyable by the first and second connectors of the present disclosure can be similarly enjoyed. Therefore, it is possible to provide a connector assembly capable of simplifying the structure of the terminal and improving the electric shock preventing effect by reducing a possibility of finger touch with the terminal.

### Details of Embodiment of Present Disclosure

Specific examples of a connector assembly, a first connector and a second connector of the present disclosure are described below with reference to the drawings. Note that the present disclosure is not limited to these illustrations, but is represented by claims and intended to include all changes in the scope of claims and in the meaning and scope of equivalents.

### Embodiment

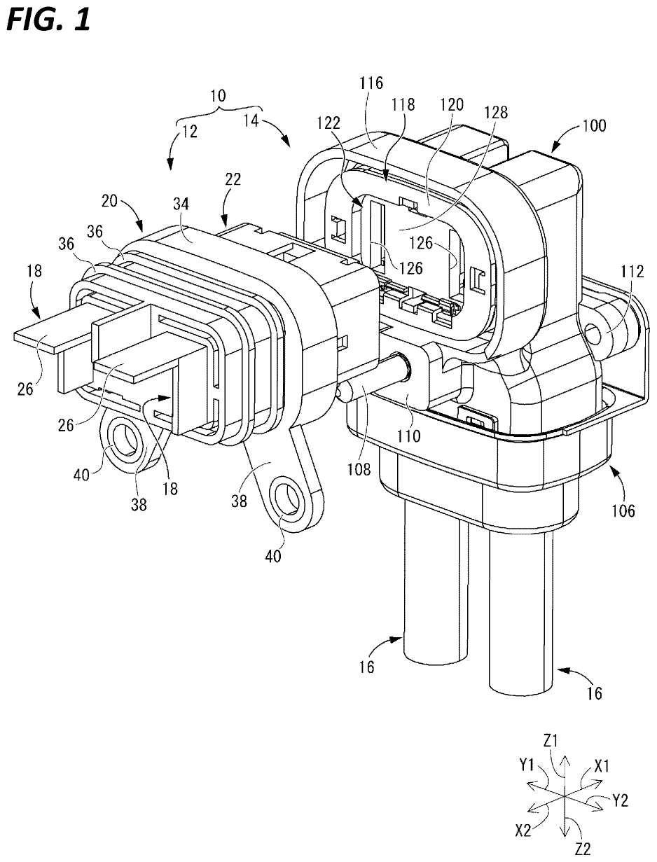

Hereinafter, a connector assembly 10 of one embodiment of the present disclosure is described with reference to FIGS. 1 to 12. The connector assembly 10 is, for example, installed in a vehicle to connect in-vehicle devices such as a high voltage battery and an inverter. Note that the connector assembly 10 can be arranged in an arbitrary orientation. In the following description, X1, X2, Y1, Y2, Z1 and Z2 shown in FIG. 1 denote a front side, a rear side, a left side, a right side, an upper side and a lower side. Further, for a plurality of identical members, only some members may be denoted by a reference sign and the other members may not be denoted by the reference sign.

### Connector Assembly 10

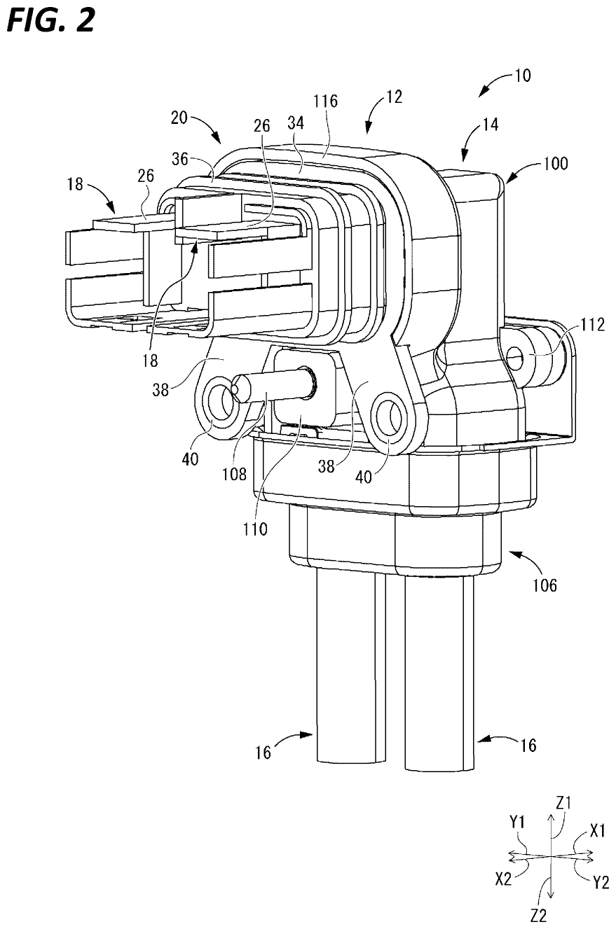

As shown in FIGS. 1 and 2, the connector assembly 10 includes a first connector 12 and a second connector 14 to be detachably assembled with the first connector 12. The first connector 12 is, for example, provided on a casing of an unillustrated high voltage battery. The second connector 14 is, for example, provided on ends of wiring harnesses 16 extending from an unillustrated inverter. As shown in FIG. 2, the first and second connectors 12, 14 are assembled with and connected to each other, whereby the battery and the inverter are connected via the wiring harnesses 16.

### First Connector 12

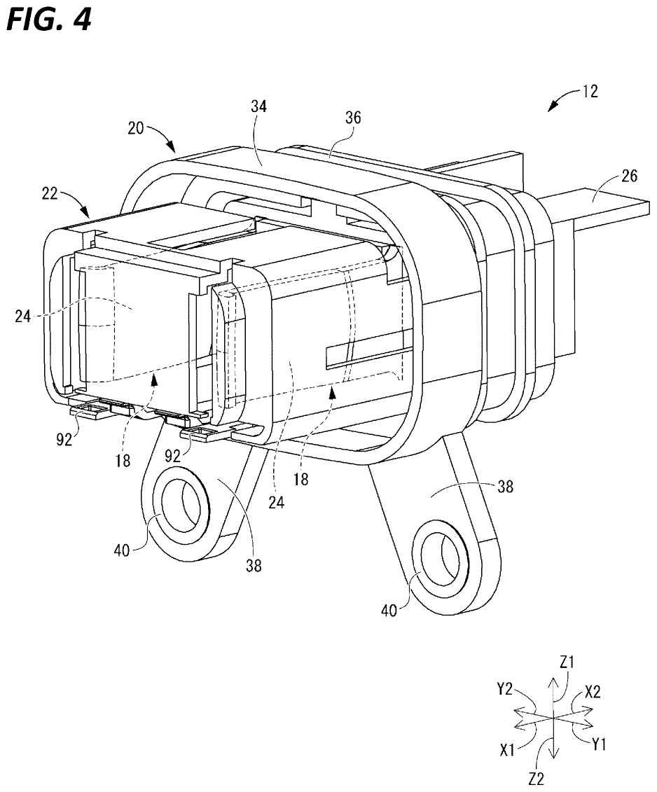

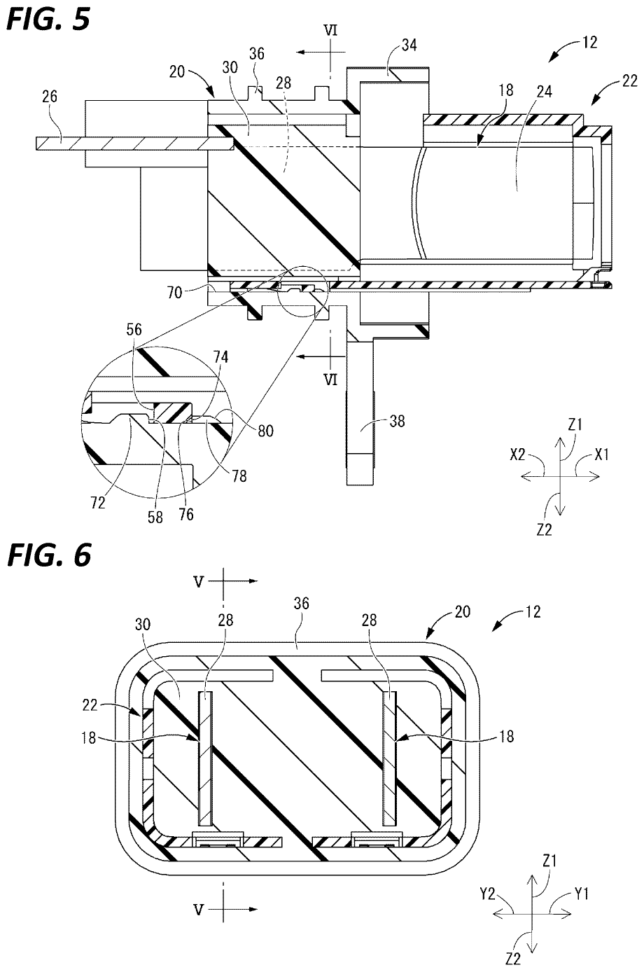

As shown in FIGS. 4 to 7, the first connector 12 is provided with a pair of first terminal members 18, a first connector housing 20 for holding the first terminal members 18 and a slide member 22 slidably held in the first connector. As shown in FIGS. 4 and 5, a tip side of the first terminal member 18 extends forward in an X1 direction from the first connector housing 20. In this embodiment, an extension direction of the first terminal member 18 is described as a first direction X1.

### First Terminal Members 18

The first terminal member 18 is formed by press stamping an electrically conductive metal plate material. In this embodiment, the first connector housing 20 of the first connector 12 holds two terminal members 18. The tip side of each first terminal member 18 extends in the first direction X1 from the first connector housing 20 and constitutes a connector-side connecting portion 24 to be connected to a later-described second terminal member 96 provided in the second connector 14. A base end side of each first terminal member 18 extends rearward in an X2 direction, i.e. in a first opposite direction X2, which is a direction opposite to the first direction, from the first connector housing 20. The base end side of each first terminal member 18 constitutes a device-side connecting portion 26 to be connected to a circuit on the battery side. Each first terminal member 18 includes a held portion 28 located between the tip side and the base end side to couple the connector-side connecting portion 24 and the device-side connecting portion 26. The held portion 28 is embedded and held in a later-described terminal holding portion 30 of the first connector housing 20. That is, the held portion 28 of the first terminal member 18 is embedded in the terminal holding portion 30 of the first connector housing 20, whereby the first terminal member 18 is held in the first connector housing 20. As just described, the first terminal member 18 is made only of the metal plate material and the structure thereof is simplified.

### First Connector Housing 20

The first connector housing 20 has a substantially rectangular block shape and made of an insulating resin material. As shown in FIG. 6, the first connector housing 20 includes the terminal holding portion 30 for holding the held portions 28 of the first terminal members 18 in the embedded state. The terminal holding portion 30 is a block body having a substantially rectangular cross-section and extending in a front-rear direction (X1, X2 directions). As shown in FIG. 6, the held portions 28 of the two first terminal members 18 are arrayed and embedded at two positions separated in a lateral direction (Y1, Y2 directions) in a central part of the terminal holding portion 30 with a plate width direction oriented in a vertical direction (Z1, Z2 directions).

Further, the terminal holding portion 30 is provided with a plurality of (four in this embodiment) slide rail insertion portions 32a, 32b, 32c and 32e penetrating through an outer peripheral edge part in the first direction X1. FIG. 8 shows a state where the slide member 22 is removed from the first connector 12. As shown in FIG. 8, each slide rail insertion portion 32a to 32d penetrating through the terminal holding portion 30 includes an empty space al and an empty space ß1 extending in two directions orthogonal to the first direction X1, which is the extension direction of the tip side of the first terminal member 18, i.e. in the vertical direction (Z1, Z2 directions) and the lateral direction (Y1, Y2 directions), and an empty space γ1 curvedly coupling the empty spaces α1 and β1.

As shown in FIGS. 4 and 5, a receptacle 34 in the form of a rectangular tube extending further toward an outer peripheral side than the outer peripheral surface of the terminal holding portion 30 and projecting in the first direction X1 is integrally provided on an end part on an X1 side, which is a front side of the terminal holding portion 30. Sealing protrusions 36 annularly extending and projecting toward the outer peripheral side are integrally provided at two positions separated from each other in the front-rear direction (X1, X2 directions) on the outer peripheral surface of the terminal holding portion 30. Further, fixing pieces 38 integrally project at two positions below the receptacle 34 and separated in the lateral direction (Y1, Y2 directions), and a collar 40 for bolt fastening is embedded in a projecting end part of each fixing piece 38.

That is, the first connector housing 20 is integrally molded from a synthetic resin material with the first terminal members 18 and the collars 40 as inserts. Note that the first connector housing 20 of the first connector 12 is mounted on the casing of the unillustrated battery by inserting the terminal holding portion 30 into a mounting hole provided in the casing of the battery with the device-side connecting portions 26 in the lead and placing the receptacle 34 and the fixing pieces 38 on the surface of the casing. Then, the fixing pieces 38 are fastened to fixing portions on the battery side by fastening bolts inserted through the collars 40, whereby the first connector 12 is fixed to the casing of the battery. At this time, the sealing protrusions 36 provided on the terminal holding portion 30 are pressed into contact with the mounting hole of the casing 36, thereby preventing the intrusion of water or the like into the casing through the mounting hole. In this state, the receptacle 34 of the first connector housing 20 and the connector-side connecting portions 24 of the first terminal members 18 projecting in the first direction X1 from the terminal holding portion 30 project from the casing surface of the unillustrated battery.

### Slide Member 22

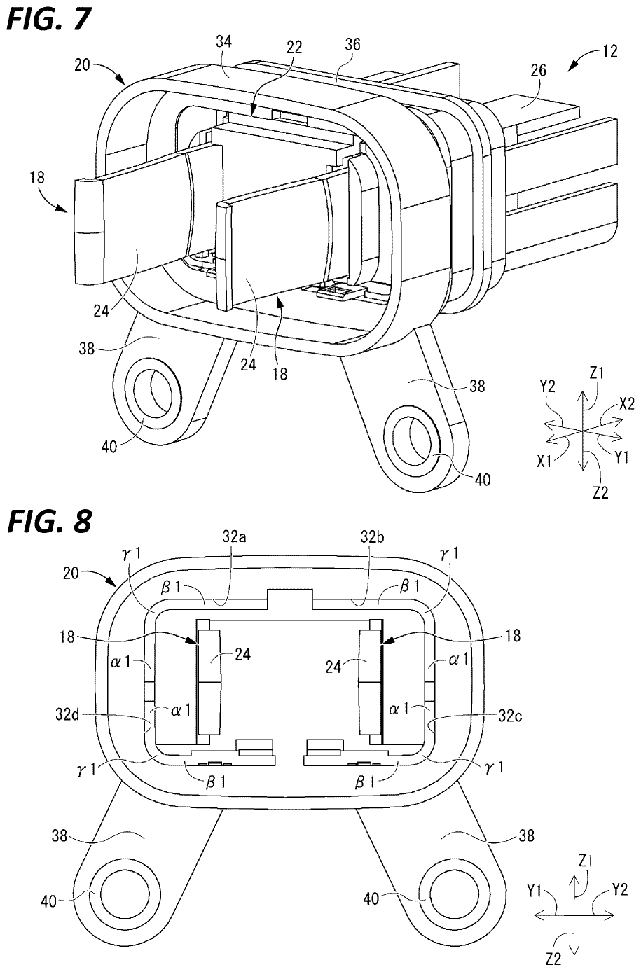

The slide member 22 is held slidably with respect to the first connector housing 20. The slide member 22 is slidable with respect to the first connector housing 20 between a closing position (see FIG. 4) located on an end part in the first connector X1 and an opening position (see FIG. 7) located on an end part in the first opposite direction X2, which is the direction opposite to the first direction X1.

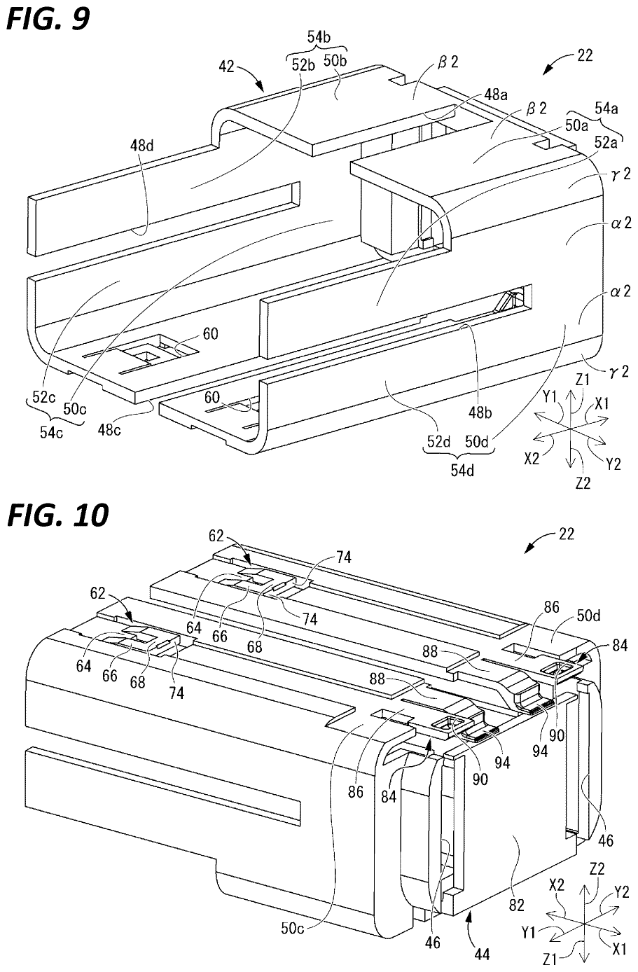

As shown in FIGS. 9 and 10, the slide member 22 has a substantially hollow rectangular tube shape as a whole and made of an insulating resin material. The slide member 22 includes a lateral protection wall portion 42 for surrounding and covering the first terminal members 18 while being separated from the first terminal members 18 in the Z1, Z2 directions and Y1, Y2 directions, which are directions orthogonal to the first direction X2 in the two first terminal members 18 at the closing position shown in FIGS. 4 and 5. The lateral protection wall portion 42 projects further in the first direction X1 than the first terminal members 18. Further, the slide member 22 includes a front protection wall portion 44 for covering a tip opening on a projecting end side of the lateral protection wall portion 42. The front protection wall portion 44 is provided with a pair of terminal insertion holes 46, through which the two first terminal members 18 are respectively inserted and which penetrate in a plate thickness direction, in parts facing the two first terminal members 18. As is clear from FIG. 4, with the slide member 22 located at the closing position, the connector-side connecting portions 24 of the respective first terminal members 18 projecting from the casing surface of the unillustrated battery are surrounded and covered by the lateral protection wall portion 42 and the front protection wall portion 44 of the slide member 22. Therefore, touch with the connector-side connecting portions 24 of the respective first terminal members 18 is prevented or suppressed by the slide member 22 at the closing position.

The lateral protection wall portion 42 of the slide member 22 includes a plurality of (four in this embodiment) divided wall portions 50a, 50b, 50c and 50d divided in a circumferential direction of the lateral protection wall portion 42 via a plurality of (four in this embodiment) slits 48a, 48b, 48c and 48d. Any of the divided wall portions 50a to 50d includes a wall α2 and a wall β2 extending in the two directions orthogonal to the first direction X1, which is the extension direction of the tip side of the first terminal member 18, i.e. in the vertical direction (Z1, Z2 directions) and the lateral direction (Y1, Y2 directions), and a curved wall γ2 coupling the walls α2 and β2. Note that, since any of the divided wall portions 50a to 50d is structured such that the walls α2, β2 extending in the vertical direction and the lateral direction, which are two orthogonal directions, are coupled by the curved wall γ2, the rigidity of each divided wall portion 50a to 50d is advantageously ensured and the durability of the slide member 22 can be improved.

Each divided wall portion 50a, 50b includes an extending wall portion 52a, 52b extending in the first opposite direction X2 toward the rear side from the wall α2. Further, each divided wall portion 50c, 50d includes an extending wall portion 52c, 52d extending in the first opposite direction X2 rearward from all of the walls α2, β2 and γ2. In this embodiment, a slide rail 54a is configured by the divided wall portion 50a and the extending wall portion 52a, a slide rail 54b is configured by the divided wall portion 50b and the extending wall portion 52b, a slide rail 54c is configured by the divided wall portion 50c and the extending wall portion 52c, and a slide rail 54d is configured by the divided wall portion 50d and the extending wall portion 52d. Further, the slide rails 54a to 54d of the slide member 22 are provided at positions and in sizes to respectively face the slide rail insertion portions 32a to 32d penetrating through the terminal holding portion 30 of the first connector housing 20. The slide rails 54a to 54d extend in the front-rear direction (X1, X2 directions) while having a slightly smaller cross-sectional shape than the slide rail insertion portions 32a to 32d to be insertable into the corresponding slide rail insertion portions 32a to 32d.

By respectively inserting and arranging the slide rails 54a to 54d of the slide member 22 in the slide rail insertion portions 32a to 32d penetrating through the terminal holding portion 30 of the first connector housing 20, the slide member 22 is held in the first connector housing 20 in a state slidable between the closing position shown in FIG. 4 and the opening position shown in FIG. 7.

### Slide-Side Suppressing Portion 56/Connector-Side Suppressing Portion 58

As shown in FIG. 5, the slide member 22 includes a slide-side suppressing portion 56 provided on the extending wall portion 52d. The first connector housing 20 includes a connector-side suppressing portion 58 for suppressing a movement of the slide member 22 in the first opposite direction X2 by being engaged with the slide-side suppressing portion 56 with the slide member 22 located at the closing position, and the connector-side suppressing portion 58 projects in the slide rail insertion portion 32d.

Specifically, as shown in FIG. 9, a through portion 60 penetrating in the plate thickness direction and a resilient deflecting piece 62 extending in the first direction X1 from an inner edge part of the through portion 60 on the side of the first opposite direction X2 are provided on a tip side in an extension direction (first opposite direction X2) of the extending wall portion 52c, 52d of the slide member 22. The resilient deflecting piece 62 includes a base piece 64, both side pieces 66 extending in the first direction X1 from both side edge parts of the base piece 64 and a coupling piece 68 coupling tip parts of the both side pieces 66. As shown in FIGS. 5 and 9, the slide-side suppressing portion 56 is constituted by a surface of the coupling piece 68 on the side of the first opposite direction X2.

As shown in FIGS. 5 and 8, the connector-side suppressing portion 58 projects on a bottom surface 70 defining each empty space β1 in the slide rail insertion portions 32c, 32d, in which the extending wall portions 52c, 52d are respectively inserted and arranged at the closing position of the slide member 22. That is, a suppressing protrusion 72 projecting upward (Z1 direction) is provided on the bottom surface 70. The connector-side suppressing portion 58 inclined in the first opposite direction X2 toward a top part of the suppressing protrusion 72 is constituted by a surface of the suppressing protrusion 72 on the side of the first direction X1.

As shown in FIG. 5, even if a force is applied in the first opposite direction X2 in a state where the slide member 22 is at the closing position, the slide member 22 is suppressed from moving in the first opposite direction X2 by the engagement of the slide-side suppressing portion 56 with the connector-side suppressing portion 58 until a force of a set value or greater is applied. If a force of the set value or greater is applied in the first opposite direction X2 in the state where the slide member 22 is at the closing position, the resilient deflecting pieces 62 are deflected and the coupling pieces 68 ride over the suppressing protrusions 72 and the slide-side suppressing portion 56 is disengaged from the connector-side suppressing portion 58 and moves in the first opposite direction X2.

### Slide-Side Restricting Portions 74/Connector-Side Restricting Portions 76

The slide member 22 includes slide-side restricting portions 74, and the first connector housing 20 includes connector-side restricting portions 76 for restricting a movement of the slide member 22 in the first direction X1 by being engaged with the slide-side restricting portions 74 with the slide member 22 located at the closing position.

Specifically, the slide-side restricting portion 74 of this embodiment is constituted by surfaces in the first direction X1 of the both side pieces 66 of the resilient deflecting piece 62 provided in each of the extending wall portions 52c, 52d of the slide member 22 as shown in FIG. 10. On the other hand, at the closing position of the slide member 22, the connector-side restricting portion 76 projects on the bottom surface 70 defining each empty space β1 in the slide rail insertion portions 32c, 32d, in which the extending wall portions 52c, 52d are respectively inserted and arranged. That is, as shown in FIG. 8, a pair of restricting protrusions 78 projecting upward (Z1 direction) are provided at positions corresponding to the pair of slide-side restricting portions 74 on each bottom surface 70. The connector-side restricting portion 76 is constituted by a surface in the first opposite direction X2 of the restricting protrusion 78. Further, a surface in the first direction X1 of the restricting protrusion 78 is formed into an inclined surface 80 inclined in the first opposite direction X2 toward a top part of the restricting protrusion 78.

The slide member 22 is restricted from moving in the first direction X1 by the engagement of the slide-side restricting portions 74 with the connector-side restricting protrusions 76 even if a force is applied in the first direction X1 in the state where the slide member 22 is at the closing position. Note that, since the flat surfaces of the slide-side restricting portions 74 and the connector-side restricting portions 76 orthogonal to the first direction X1 are engaged, it is suppressed that the resilient deflecting pieces 62 are deflected and the coupling pieces 68 ride over the restricting protrusions 78.

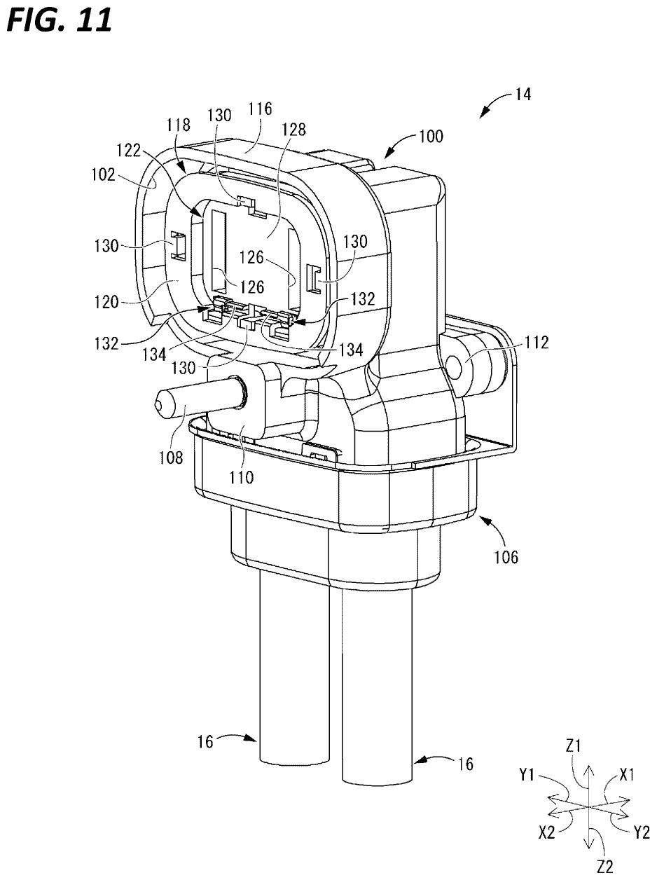

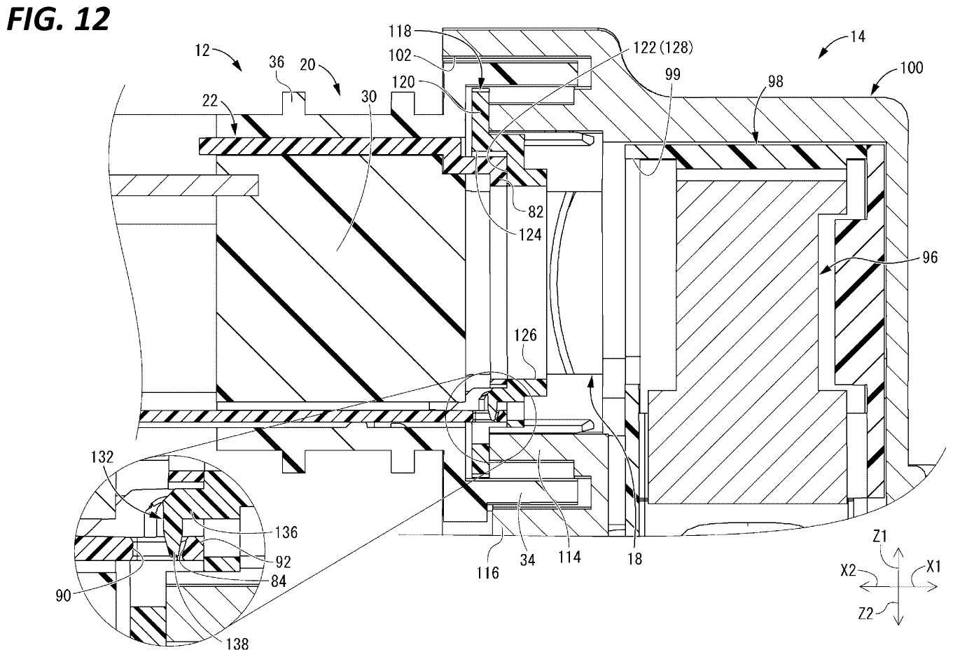

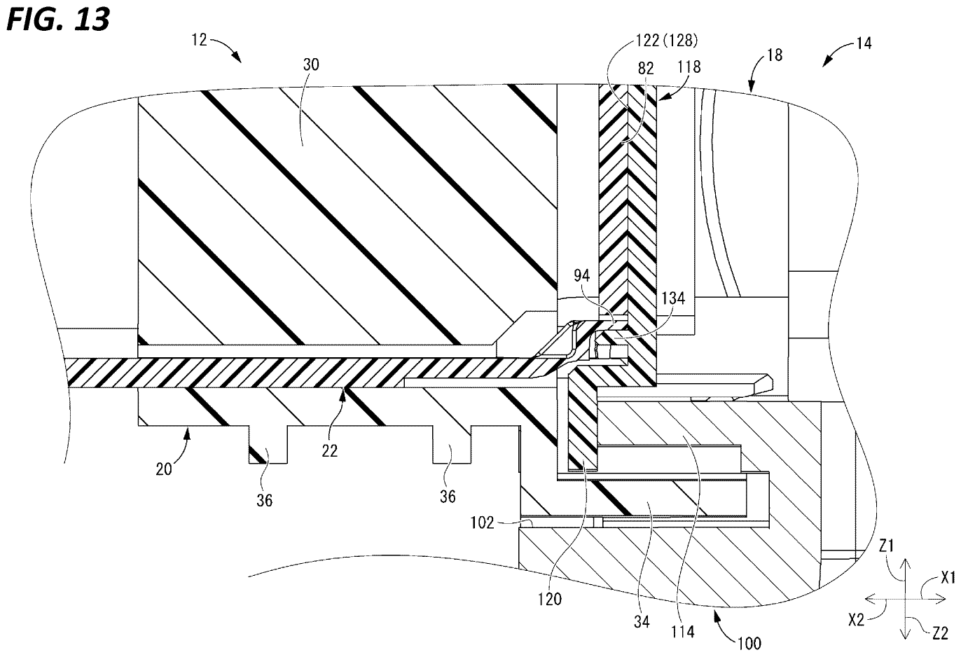

The slide member 22 includes a pressed portion 82 to be pressed by a later-described pressing portion 128 (see FIGS. 11 and 12) provided in the second connector 14 when the second connector 14 is attached to the first connector 12. In this embodiment, the pressed portion 82 is constituted by a wide planar region of the front protection wall portion 44 of the slide member 22 except the terminal insertion holes 46. That is, the pressed portion 82 is provided on the front protection wall portion 44. The slide member 22 slides to the opening position by the pressed portion 82 being pressed by the pressing portion 128.

The slide member 22 includes engaged portions 84 to be engaged with later-described engaging portions 132 (see FIGS. 11 and 12) provided in the second connector 14 and pulled in the first direction X1, which is a separation direction of the second connector 14, when the second connector 14 is separated from the first connector 12. The slide member 22 slides to the closing position by the engaged portions 84 being pulled by the engaging portions 132.

As shown in FIG. 10, the slide member 22 includes a pair of flexible pieces 86 arranged apart from each other in the latera direction (Y1, Y2 directions) and a pair of central pieces 88 likewise arranged apart from each other in the latera direction between the pair of flexible pieces 86 on front sides (X1 sides) of the walls β2 of the divided wall portions 50c, 50d. Each flexible piece 86 is in the form of a cantilever coupled to the wall β2 and includes a base end part and a tip part provided on an opposite side in the first direction X1. The flexible piece 86 extends in the first direction X1 from the wall β2 and is deflectable and deformable downward in the Z2 direction orthogonal to the first direction X1.

The tip part of each flexible piece 86 includes an engaging hole 90 penetrating in the plate thickness direction. The engaged portion 84 is constituted by an inner wall surface of the engaging hole 90 on the side of the first direction X1 (see FIG. 12). Two engaged portions 84 are provided by being respectively provided on the flexible pieces 86. Further, the engaged portion 84 is inclined toward the X1 side with respect to a plane orthogonal to an attachment/detachment direction of the first and second connectors 12, 14. Therefore, the engaged portion 84 guides the engaging portion 132 to be disengaged therefrom with the slide member 22 located at the closing position when the second connector 14 is detached from the first connector 12.

A projecting end part of each flexible piece 86 is provided with a guiding surface 92 inclined in the first opposite direction X2 with respect to the plane orthogonal to the attachment/detachment direction of the first and second connectors 12, 14. The guiding surface 92 guides the engaging portion 132 to a position engageable with the engaged portion 84 when the second connector 14 is attached to the first connector 12.

A projecting tip (X1 side) of each central piece 88 is provided with a contacted portion 94 in the form of a flat plate located above the engaging hole 90 of each flexible piece 86 on the Z1 side and projecting in the first direction X1. A pair of the contacted portions 94 provided in the slide member 22 are brought into contact with a pair of later-described contact portions 134 provided in the second connector 14 from a side (Z1 side) opposite to a projecting side (Z2 side) of the engaging portions 132 to the engaged portions 84 (see FIG. 13). By the contact of each contacted portion 94 with each contact portion 134, the engaging portion 132 can be hindered from being displaced in a direction opposite to a projecting direction to the engaged portion 84.

### Second Connector 14

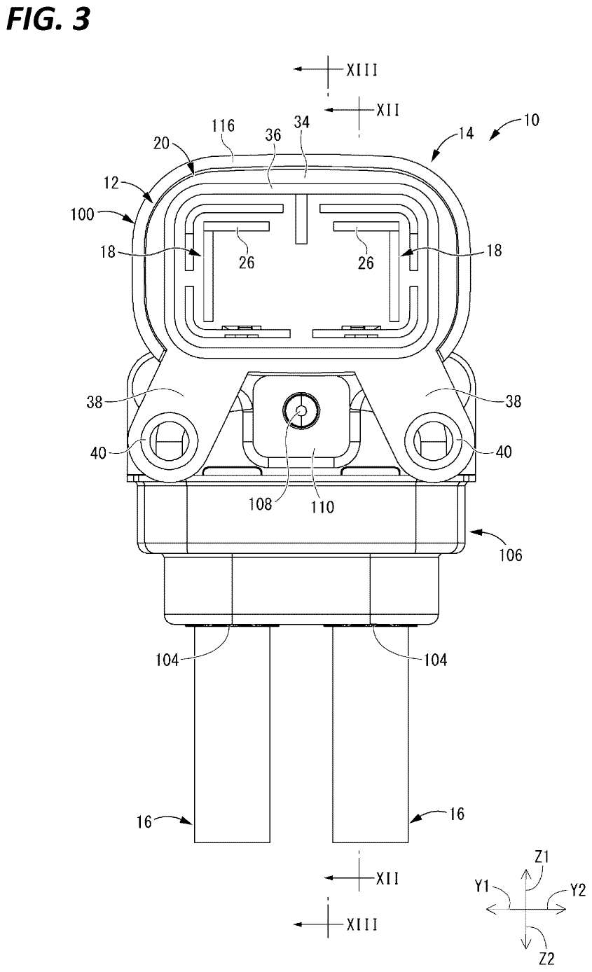

As shown in FIGS. 1, 11 and 12, the second connector 14 is provided with the second terminal members 96 and an insulating second connector housing 98 for holding the second terminal members 96. As also shown in FIGS. 3, 12 and the like, the second connector 14 is configured such that two second terminal members 96 respectively connected to ends of the two wiring harnesses 16 are accommodated and held inside the second connector housing 98 in this embodiment. A tip side of each second terminal member 96 extends upward (Z1 direction) from the end of the wiring harness 16. The second terminal members 96 in the second connector housing 98 are exposed to outside via an opening window 99 provided in the second connector housing 98. The second connector housing 98 is detachably assembled with the first connector housing 20.

The second connector 14 is further provided with a shield shell 100 made of metal for surrounding the outer surface of the second connector housing 98. The shield shell 100 is in the form of a hollow rectangular box and open outward in a connector mounting opening 102 open in the first opposite direction X2 and a wire pull-out opening 104 open downward (Z2 direction), which is an extension direction of the wiring harnesses 16 from the second terminal members 96. A shield bracket 106 in the form of a stepped tube is mounted on the wire pull-out opening 104 to cover the wire pull-out opening 104. The wiring harnesses 16 pulled out through the wire pull-out opening 104 of the shield shell 100 are pulled out to outside through the shield bracket 106. The shield shell 100 includes a fixing portion 110 having a fastening bolt 108 mounted therein and can be fastened to the casing of the unillustrated battery provided with the first connector 12 by the fastening bolt 108 in the fixing portion 110. Similarly, the shield bracket 106 is also provided with a fixing portion 112 and can be fixed to the casing of the unillustrated battery by an unillustrated bolt.

The connector mounting opening 102 of the shield shell 100 has a double tube structure including an inner peripheral frame body 114 substantially in the form of a rectangular frame and an outer peripheral frame body 116 substantially in the form of a rectangular frame concentrically arranged on an outer peripheral side of the inner periphery frame body across a gap, and projects in the first opposite direction X2. A front retainer 118 in the form of a stepped plate, which is an insulating lid member, is mounted on the inner periphery frame body 114 of the connector mounting opening 102. By covering the connector mounting opening 102 by the front retainer 118, the opening window 99 of the second connector housing 98 is covered and the exposure of the second terminal members 96 accommodated in the second connector housing 98 and exposed through the opening window 99 to outside is suppressed.

As shown in FIG. 12, the front retainer 118 is configured to have a substantially rectangular shape in a plan view and has such a stepped plate shape that an annular outer peripheral edge portion 120 and a central planar portion 122 located forward of the outer peripheral edge portion 120 in the first direction X1 are coupled via a step surface 124. The central planar portion 122 of the front retainer 118 is provided with a pair of first terminal accommodation holes 126 penetrating in a plate thickness direction. When the first and second connectors 12, 14 are connected, the connector-side connecting portions 24 of the first terminal members 18 of the first connector 12 are inserted into the second connector housing 98 through the first terminal accommodation holes 126 and connected to the second terminal members 96. The pressing portion 128 for pressing the pressed portion 82 provided in the slide member 22 of the first connector 12 is constituted by a part of the central planar portion 122 of the front retainer 118 except the first terminal accommodation holes 126, and the pressing portion 128 presses the pressed portion 82 to slide the slide member 22 to the opening position when the first and second connectors 12, 14 are connected.

As shown in FIG. 11, the outer peripheral edge portion 120 of the front retainer 118 is provided with resilient lock portions 130 at four positions separated in a circumferential direction, and unillustrated locked portions provided in the first connector housing 20 are detachably fit to the resilient lock portions 130. Further, the pair of engaging portions 132 and the pair of contact portions 134 are respectively provided on both sides in the lateral direction (Y1, Y2 directions) across the resilient lock portion 130 in an inner wall portion located on a lower side (Z1 side) of the outer peripheral edge portion 120.

The respective engaging portions 132 provided in the front retainer 118 are provided at positions corresponding to the engaged portions 84 of the slide member 22. Each engaging portion 132 is engaged with the engaged portion 84 to pull the engaged portion 84 in the separation direction (X1 direction) from the first connector, thereby sliding the slide member 22 to the closing position, when the second connector 14 is separated from the first connector 12.

Specifically, as shown in FIG. 12, the engaging portion 132 integrally includes a protrusion 136 projecting in the first opposite direction X2 from the central planar portion 122 of the front retainer 118 and a claw 138 projecting downward (Z2 direction) from a position corresponding to the engaged portion 84 on the tip of the protrusion 136. The claw 138 has a shape tapered in a projecting direction (Z2 direction) and is deflectable and deformable in the front-rear direction (X1, X2 directions). The guiding surface 92 inclined toward the engaging hole 90 is provided on the tip of the flexible piece 86 of the slide member 22. By this guiding surface 92, the claw 138 of the engaging portion 132 rides over the guiding surface 92 while contacting the guiding surface 92 and being deflected and deformed and the engaging portion 132 is guided to the position engageable with the engaging hole 92 when the first and second connectors 12, 14 are attached.

The respective contact portions 134 provided in the front retainer 118 are provided at positions corresponding to the contacted portions 94 of the slide member 22. In a state shown in FIG. 12 where the engaging portions 132 are engaged with the engaging holes 90, each contact portion 132 is in contact with the contacted portion 94 provided in the slide member 22 from the direction opposite to the projecting direction of the engaging portion 132 to the engaged portion 84 as shown in FIG. 13. In this way, a displacement of the engaging portion 132 in the direction (Z2 direction) opposite to the projecting direction (Z1 direction) is hindered, and the engaging portion 132 can be held in the engaging hole 90 and stably maintained in a state engaged with the engaged portion 84.

In the attached state of the first and second connectors 12, 14 shown in FIG. 12, the receptacle 34 provided in the first connector housing 20 of the first connector 12 is accommodated in an accommodation space provided between the inner periphery frame body 114 and the outer periphery frame body 116 of the shield shell 100. In this way, the receptacle 34 of the first connector 12 can be covered over an entire periphery by the shield shell 100 and a shielding effect by the shield shell 100 can be stably ensured.

In the connector assembly 10 of this embodiment, the first and second connectors 12, 14 configured as described above are assembled into the attached state shown in FIG. 2 from an unattached state shown in FIG. 1, whereby the first terminal members 18 provided in the first connector 12 and the second terminal members 96 provided in the second connector 14 can be held in a connected state.

In the unattached state shown in FIG. 1, the slide member 22 of the first connector 12 is at the closing position. Thus, the lateral protection wall portion 42 covers the first terminal members 18 and the front protection wall portion 44 covering the tip opening of the lateral protection wall portion 42 covers the front surfaces of the first terminal members 18. Therefore, a possibility of finger touch with the first terminal members 18 is reduced and an electric shock preventing effect can be improved. As a result, an insulating component needs not be mounted on the first terminal member 18 unlike before, the first terminal member 18 can be constituted only by a metal member, and the structure of the first terminal member 18 can be simplified.

Moreover, when the slide member 22 of the first connector 12 is at the closing position, the slide-side suppressing portion 56 provided on the slide member 22 is in contact with the connector-side suppressing portion 58 provided in the first connector housing 20, thereby suppressing a movement of the slide member 22 in the first opposite direction X2. Therefore, it can be prevented that the slide member 22 is moved in the first opposite direction X2 by an accidental external force to expose the first terminal members 18. As a result, the electric shock preventing effect for the first terminal members 18 can be satisfactorily maintained.

Further, when the slide member 22 of the first connector 12 is at the closing position, the slide-side restricting portions 74 provided in the slide member 22 are in contact with the connector-side restricting portions 76 provided in the first connector housing 20, whereby a movement of the slide member 22 in the first direction X1 is restricted. Therefore, it can be prevented that the slide member 22 is detached from the first connector housing 20 by an accidental external force and the first terminal members 18 are exposed. As a result, the electric shock preventing effect for the first terminal members 18 can be satisfactorily maintained.

Subsequently, when the second connector 14 is attached to the first connector 12, the connector mounting opening 102 of the shield shell 100 of the second connector 14 is caused to face the front protection wall portion 44 of the slide member 22 of the first connector 12 in the first direction X1. Then, if the second connector 14 is brought even closer to the first connector 12, the front protection wall portion 44 of the slide member 22 of the first connector 12 comes into contact with the central planar portion 122 of the front retainer 118 of the second connector 14. The pressed portion 82 is constituted by the part of the front protection wall portion 44 except the terminal insertion holes 46, and the pressing portion 128 is constituted by the part of the central planar portion 122 except the first terminal accommodation holes 126. The slide member 22 slides to the opening position by the pressed portion 82 thereof being pressed by the pressing portion 128 of the second connector 14. That is, by an attaching operation of the first and second connectors 12, 14, the slide member 22 can be slid to the opening position without requiring a jig or the like.

In this embodiment, the pressing portion 128 is constituted by the wide planar region except the first terminal accommodation holes 126 in the central planar portion 122 of the front retainer 118. The pressed portion 82 of the slide member 22 is also constituted by the wide planar region of the front protection wall portion 44 except the terminal insertion holes 46. Therefore, the pressing portion 128 and the pressed portion 82 can be brought into surface contact with each other over a wide contact area, a stable sliding movement of the slide member 22 can be realized, and the occurrence of troubles such as a movement of the slide member in an inclined state can be advantageously suppressed.

Next, movements in separating the second connector 14 attached to the first connector 12 shown in FIG. 2 from the first connector 12 are described. As shown in FIG. 12, in the attached state of the first and second connectors 12, 14, the engaging portions 132 provided in the second connector 14 project into the engaging holes 90 provided in the flexible pieces 86 of the slide member 22 of the first connector 12. If the second connector 14 is moved in the first direction X1, which is the separation direction, from this state, the engaging portions 132 are engaged with the engaged portions 84 defining the engaging holes 90 and transmit a displacement force in the first direction X1 applied to the second connector 14 to the engaged portions 84. As a result, the engaged portions 84 and, consequently, the slide member 22 can be moved in the first direction X1 by the engaging portions 132 and the slide member 22 can be moved to the closing position.

The slide member 22 moved to the closing position is restricted from being displaced in the first direction X1 any further by the contact of the slide-side restricting portions 74 with the connector-side restricting portions 76. Thus, the displacement force in the first direction X1 applied to the second connector 14 induces further resilient deformation of the engaging portions 132, the engaging portions 132 come out from the engaging holes 90 and the second connector 14 is separated and divided from the first connector 12. As just described, the slide member 22 needs not be slid by a jig or the like and can be slid to the closing position without requiring a separate step only by detaching the second connector 14 from the first connector 12.

Particularly, in this embodiment, the contacted portions 94 provided in the slide member 22 come into contact with the contact portions 134 provided in the second connector near the engaging portions 132, thereby hindering displacements of the engaging portions 132 in the direction opposite to the projecting direction. In this way, the escape of the engaging portions 132 from the engaging holes 90 can be hindered and the engaged state of the engaging portions 132 with the engaged portions 84 can be advantageously held. In this way, when the second connector 14 is separated from the first connector 12, it is possible to suppress the occurrence of a trouble that the engaging portions 132 are disengaged from the engaged portions 84 and the slide member 22 cannot be pulled to the closing position.

Here, in the first connector 12, the slide member 22 includes the slide rails 54a to 54d, and the slide member 22 is held slidable in the front-rear direction (first direction X1, first opposite direction X2) with respect to the first connector housing 20 by inserting and arranging the slide rails 54a to 54d in the slide rail insertion portions 32a to 32d of the first connector housing 20. Displacements of the slide member 22 in the directions orthogonal to the first direction X1 are restricted by the contact of the slide rails 54a to 54d with the slide rail insertion portions 32a to 32d. In this way, an inclined sliding movement of the slide member 22 and the like can be advantageously suppressed and it is possible to prevent the breakage of the slide member and improve the durability of the slide member.

Particularly, in this embodiment, the lateral protection wall portion 42 is divided in the circumferential direction into the plurality of divided wall portions 50a to 50d by the plurality of slits 48a to 48d, whereby the slide rails 54a to 54d can be configured, using the divided wall portions 50a to 50d. That is, as shown in FIG. 12, at the opening position of the slide member 22, the divided wall portions 50a to 50d are respectively accommodated in the slide rail insertion portions 32a to 32d and function as slide rails. On the other hand, at the closing position of the slide member 22 shown in FIGS. 4 to 6, the divided wall portions 50a to 50d function as the lateral protection wall portion 42 and the extending wall portions 52a to 52d are respectively accommodated in the slide rail insertion portions 32a to 32d and function as slide rails. As just described, in this embodiment, the slide member 22 is made multi-functional and also reduced in size with a small number of components. Further, a sliding movement of the slide member can be stably realized by inserting and arranging any parts of the slide rails 54a to 54d in the slide rail insertion portions 32a to 32d during the sliding movement of the slide member 22 from the closing position to the opening position.

In this embodiment, the slide rails 54a to 54d inserted and arranged in the slide rail insertion portions 32a to 32d are arranged to face each other on both sides across the first terminal members 18 in the two directions orthogonal to the first direction X1. For example, in the vertical direction (Z1, Z2 directions) orthogonal to the first direction X1, a pair of the slide rail 54a and slide rail insertion portion 32a and a pair of the slide rail 54d and the slide rail insertion portion 32d are arranged to face each other, and a pair of the slide rail 54b and slide rail insertion portion 32b and a pair of the slide rail 54c and the slide rail insertion portion 32c are arranged to face each other. In the lateral direction (Y1, Y2 directions) orthogonal to the first direction X1, the pair of the slide rail 54a and slide rail insertion portion 32a and the pair of the slide rail 54b and the slide rail insertion portion 32b are arranged to face each other, and the pair of the slide rail 54c and slide rail insertion portion 32c and the pair of the slide rail 54d and the slide rail insertion portion 32d are arranged to face each other. In such a configuration, the rigidity and durability of the slide member 22 can be more advantageously ensured and a sliding movement of the slide member 22 is more stably guided.

In this embodiment, since the two first terminal members 18 are covered by the lateral protection wall portion 42 and the front protection wall portion 44 of the single slide member 22 located at the closing position, the slide member 22 can be commonly used by the two first terminal members 18 and a reduction in the number of component and miniaturization of the first connector 12 can be achieved.

### Modifications

Although the embodiment has been described in detail as a specific example of the present disclosure above, the present disclosure is not limited by this specific description. Modifications, improvements and the like within a range in which the aim of the present disclosure can be achieved are included in the present disclosure. For example, the following modifications of the embodiment are also included in the technical scope of the present disclosure.
(1) Although the plurality of first terminal members 18 are covered by the single slide member 22 in the first connector 22 of the above embodiment, each first terminal member 18 may be covered by a separate slide member 22.
(2) Although the engaging portions 132 and the contact portions 134 are provided in the front retainer 118 serving as the insulating lid member in the second connector 14 of the above embodiment, there is no limitation to this. For example, if the second connector 14 does not include the shield shell 100, engaging portions and contact portions may be provided in an insulating lid member for directly covering the opening window 99 of the second connector housing 98 or may be integrally provided to the second connector housing 98.
(3) Although the slide member 22 is moved from the closing position to the opening position by the pressing portion 128 pressing the pressed portion 82, there is no limitation to this and the slide member 22 may be moved using a jig or the like. Similarly, although the slide member is moved from the opening position to the closing position by the engaging portions 132 pulling the engaged portions 84 in the first direction X1, there is no limitation to this. For example, the slide member 22 may be moved using a jig or the like or may be moved, utilizing a biasing force of a biasing member.
(4) The specific configurations of the slide-side suppressing portion 56 and the connector-side suppressing portion 58 are not limited to those illustrated in the above embodiment, but any shape and configuration can be adopted if a movement of the slide member 22 at the closing position in the first opposite direction X2 can be suppressed.
(5) The specific configurations of the slide-side restricting portions 74 and the connector-side restricting portions 76 are not limited to those illustrated in the above embodiment, but any shape and configuration can be adopted if a movement of the slide member 22 at the closing position in the first direction X1 can be restricted.
(6) Although the first connector 12 is provided with the two first terminal members 18 in the above embodiment, one, three or more first terminal members 18 may be provided.

### LIST OF REFERENCE NUMERALS

10 connector assembly
12 first connector
14 second connector
16 wiring harness
18 first terminal member
20 first connector housing
22 slide member
24 connector-side connecting portion
26 device-side connecting portion
28 held portion
30 terminal holding portion
32a to 32d slide rail insertion portion
34 receptacle
36 sealing protrusion
38 fixing piece
40 collar
42 lateral protection wall portion
44 front protection wall portion
46 terminal insertion hole
48a to 48d slit
50a to 50d divided wall portion
52a to 52d extending wall portion
54a to 54d slide rail
56 slide-side suppressing portion
58 connector-side suppressing portion
60 through portion
62 resilient deflecting piece
64 base piece
66 side piece
68 coupling piece
70 bottom surface
72 suppressing protrusion
74 slide-side restricting portion
76 connector-side restricting portion
78 restricting protrusion
80 inclined surface
82 pressed portion
84 engaged portion
86 flexible piece
88 central piece
90 engaging hole
92 guiding surface
94 contacted portion
96 second terminal member
98 second connector housing
99 opening window
100 shield shell
102 connector mounting opening
104 wire pull-out opening
106 shield bracket
108 fastening bolt
110 fixing portion
112 fixing portion
114 inner peripheral frame body
116 outer peripheral frame body
118 front retainer (insulating lid member)
120 outer peripheral edge portion
122 central planar portion
124 step surface
126 first terminal accommodation hole
128 pressing portion
130 resilient lock portion
132 engaging portion
134 contact portion
136 protrusion
138 claw
α1 empty space extending in vertical direction
β1 empty space extending in lateral direction
γ1 empty space curvedly coupling α1 and β1
α2 wall extending in vertical direction
β2 wall extending in lateral direction
γ2 wall curvedly coupling α2 and β2

1. A first connector to be detachably assembled with a second connector, comprising:
a first terminal member having a tip side extending in a first direction;
a first connector housing for holding the first terminal member; and
a slide member held in the first connector housing,
the slide member being slidable with respect to the first connector housing between a closing position located on an end part in the first direction and an opening position located on an end part in a first opposite direction opposite to the first direction,
the slide member including a lateral protection wall portion projecting further in the first direction than the first terminal member while being separated from the first terminal member and covering the first terminal member in a direction orthogonal to the first direction in the first terminal member at the closing position, a front protection wall portion for covering a tip opening of the lateral protection wall portion and a terminal insertion hole provided through the front protection wall portion to allow insertion of the first terminal member, and
the first terminal member being inserted through the terminal insertion hole of the slide member and projecting in the first direction from the front protection wall portion with the slide member moved to the opening position.

2. The first connector of claim 1, wherein a plurality of the first terminal members are provided and covered by the lateral protection wall portion and the front protection wall portion of the single slide member arranged at the closing position.

3. The first connector of claim 1, wherein:
the first connector housing includes a terminal holding portion for holding a held portion located between the tip side and a base end side of the first terminal member and a slide rail insertion portion penetrating through an outer peripheral edge part of the terminal holding portion in the first direction,
the slide member includes a slide rail extending in the first opposite direction from the front protection wall portion of the slide member and the slide rail is inserted into the slide rail insertion portion movably in the first direction and the first opposite direction, and
a displacement of the slide member in a direction orthogonal to the first direction is restricted by contact of the slide rail with the slide rail insertion portion.

4. The first connector of claim 3, wherein:
the lateral protection wall portion of the slide member includes a plurality of divided wall portions divided in a circumferential direction via a plurality of slits, and
the slide rail includes the divided wall portion.

5. The first connector of claim 4, wherein the slide rail includes an extending wall portion extending in the first opposite direction from the divided wall portion and the extending wall portion of the slide rail is inserted and arranged in the slide rail insertion portion of the first connector housing at the closing position.

6. The first connector of claim 3, wherein a pair of the slide rail and the slide rail insertion portion are arranged to face each other on both sides across the first terminal member in two directions orthogonal to the first direction in the first terminal member.

7. The first connector of claim 1, wherein:
the slide member includes a slide-side suppressing portion, and
the first connector housing includes a connector-side suppressing portion for suppressing a movement of the slide member in the first opposite direction by being engaged with the slide-side suppressing portion with the slide member located at the closing position.

8. The first connector of claim 1, wherein:
the slide member includes a slide-side restricting portion, and
the first connector housing includes a connector-side restricting portion for restricting a movement of the slide member in the first direction by being engaged with the slide-side restricting portion with the slide member located at the closing position.

9. The first connector of claim 1, wherein the slide member includes a pressed portion to be pressed by a pressing portion provided in the second connector when the second connector is attached to the first connector, the pressed portion is provided in the front protection wall portion, and the slide member slides to the opening position by the pressed portion being pressed by the pressing portion.

10. The first connector of claim 1, wherein the slide member includes an engaged portion to be engaged with an engaging portion provided in the second connector and pulled in a separation direction of the second connector when the second connector is separated from the first connector, and the slide member slides to the closing position by the engaged portion being pulled by the engaging portion.

11. The first connector of claim 10, wherein the slide member includes a contacted portion to be brought into contact with a contact portion provided in the second connector from a direction opposite to a projecting direction from the engaging portion to the engaged portion, and the contacted portion hinders a displacement of the engaging portion in the direction opposite to the projecting direction by being contacted by the contact portion.

12. A second connector to be detachably assembled with the first connector of claim 1, comprising:
a second terminal member to be connected to the first terminal member of the first connector;
a second connector housing for holding the second terminal member;
a pressing portion for sliding the slide member to the opening position by pressing a pressed portion provided in the slide member when the second connector is attached to the first connector; and
an engaging portion for sliding the slide member to the closing position by being engaged with an engaged portion provided in the slide member and pulling the engaged portion in a separation direction from the first connector when the second connector is detached from the first connector.

13. The second connector of claim 12, wherein:
the second connector housing includes an opening window for exposing the second terminal member to outside, and
the second connector further includes an insulating lid member for covering the opening window, a first terminal accommodation hole is provided through a central planar portion of the lid member and the pressing portion is constituted by a part of the central planar portion except the first terminal accommodation hole.

14. The second connector of claim 12, wherein the second connector housing includes the engaging portion and a contact portion to be brought into contact with a contacted portion provided in the slide member in a direction opposite to a projecting direction of the engaging portion to the engaged portion, and the contacted portion hinders a displacement of the engaging portion in the direction opposite to the projecting direction by being contacted by the contact portion.

15. A connector assembly, comprising a first connector and a second connector to be detachably assembled with each other,
the first connector of claim 12 being used as the first connector, and
the second connector of claim 12 being used as the second connector.
